(19) United States
(12) Patent Application Publication
(10) Pub. No.: US 2007/0023961 A1
(43) Pub. Date: Feb. 1, 2007

(54) Method for making a dive mask lanes retainer

(75) Inventor: Chen-Lieh Pan, Yilan Hsien (TW)

Correspondence Address: PATENTTM.US, P. O. BOX 82788, PORTLAND, OR, 97282-0788, US

(73) Assignee: WATER SQUARE SPORTS CO., LTD.

(21) Appl. No.: 11/193,048

(22) Filed: Jul. 28, 2005

(51) Int. Cl. B29C 45/14

(52) U.S. Cl. 264/273

(57) ABSTRACT

A method for making a lens retainer for a dive mask has multiple steps comprising preparing a frame, mounting a mold on the frame, filling the mold with liquid plastic, curing the liquid plastic and removing the mold from the frame. A first step is preparing a frame having at least one opening and multiple interface holes. The at least one opening is formed through the frame. The holes are formed through the frame. A second step is mounting a mold on the frame. Then the mold and the interface holes are filled with liquid plastic to form a crown on the frame. The plastic is cured, and the mold is removed from the frame. The plastic in the interface holes form multiple rods that hold the crown on the frame.

### BACKGROUND OF THE INVENTION

1. Field of the Invention

The present invention relates to method for making a dive mask lens retainer, and more particularly to a method for making a dive mask lens retainer that does not delaminate or otherwise come apart.

2. Description of Related Art

Snorkeling and diving are very popular and require a dive mask to see clearly underwater. The mask has a main frame, a skirt, a strap, two lenses and a lens retainer. The main frame has a front, a rear, a lens recess, two sides and two buckles. The lens recess is formed in the front of the main frame and has multiple recesses formed inside the lens recess. The skirt is attached on the rear of the main frame. The buckles are mounted respectively on the sides of the main frame. The lenses are mounted in the lens recess. The strap has two ends. The ends of the strap are attached respectively to the buckles. The lens retainer has an outer edge and multiple protrusions. The protrusions are formed on and protrude from the outer edge and engage the recesses in the lens recess to hold the lenses in the main frame.

With reference to FIG. 4, a conventional lens retainer (30) substantially has an inner plastic layer (32) and an outer plastic layer (31) respectively of different colors or single color. The two plastic layers (31, 32) make the lens retainer (30) attractive. The inner plastic layer (32) has an outer surface (not numbered). The outer plastic layer (31) is only bonded to the outer surface of the inner plastic layer (32). No structure exists to hold the two plastic layers (31, 32) together. After extended use, the two plastic layers (31, 32) separate from each other and cause the lens retainer (30) to be unsightly.

To overcome the shortcomings, the present invention provides a method for making a dive mask lens retainer to obviate or mitigate the aforementioned problems.

### SUMMARY OF THE INVENTION

The primary objective of the present invention is to provide a method for making a dive mask lens retainer so the lens retainer does not come apart.

The method for making a dive mask lens retainer. A first step is preparing a frame having at least one opening and multiple conical holes. The at least one opening is formed through the frame. The holes are formed through the frame. A second step is employing a mold on top of the frame and filling the mold with liquefied plastic fluid. After the plastic fluid is cool down, a secondary frame is formed on front edge of the frame. The secondary frame has multiple rods that engage with the holes of the frame. Because the rods of the secondary and the holes of the frame are conical, the secondary frame and the frame are not able to separate from each other so the mask frame is able to keep in one piece.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a dive mask with a lens retainer in accordance with the present invention;

FIG. 2 is a perspective view of the dive mask lens retainer in FIG. 1;

FIG. 3 is an enlarged cross sectional side view of the dive mask lens retainer in FIG. 2; and

FIG. 4 is a cross sectional side view of a conventional dive mask lens retainer in accordance with the prior art.

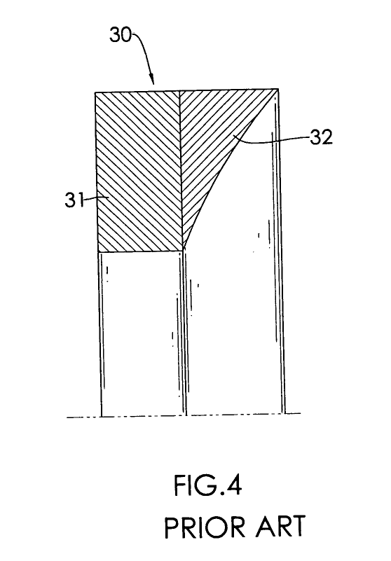

### DETAILED DESCRIPTION OF THE PREFERRED EMBODIMENT

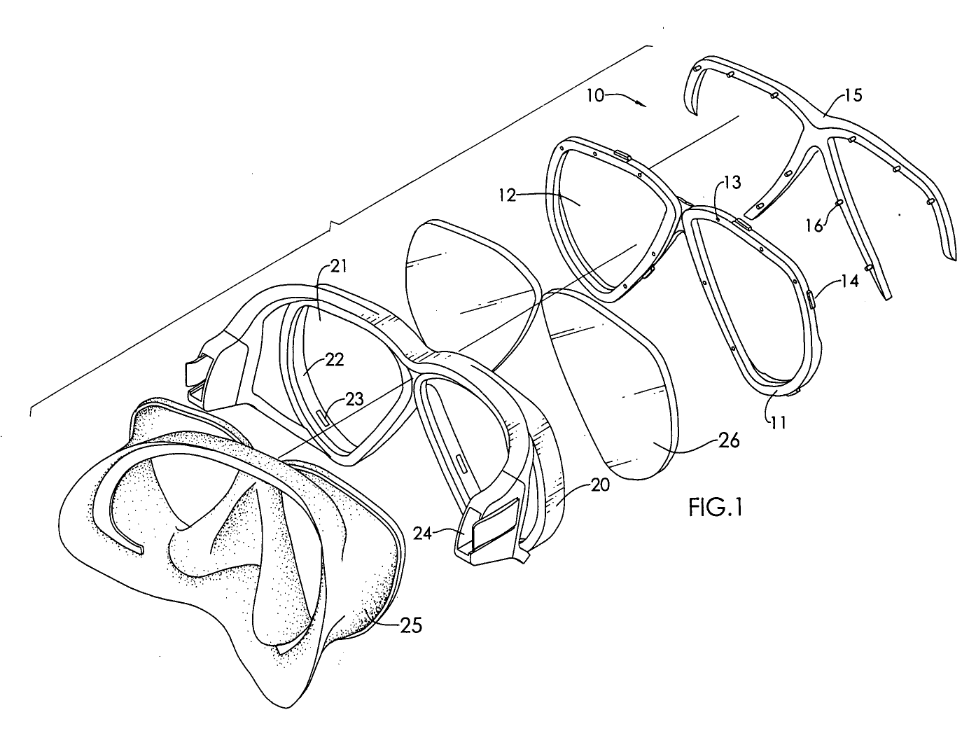

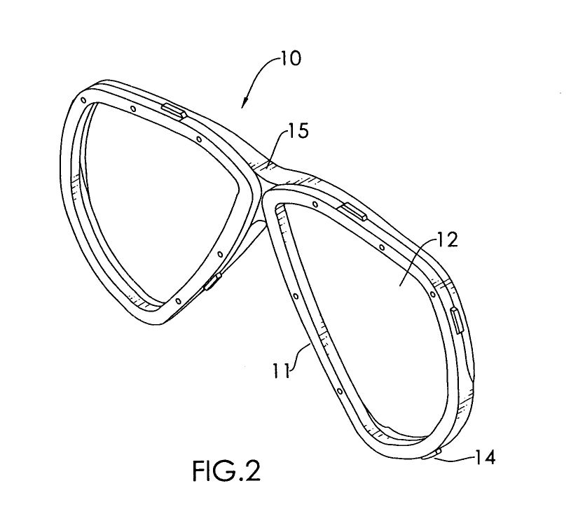

With reference to FIGS. 1 and 2, a method for making a dive mask lens retainer (10) in accordance with the present invention for a dive mask has multiple steps comprising preparing a frame (11), mounting a mold on the frame (11), filling the mold with liquid plastic, curing the liquid plastic and removing the mold from the frame (11).

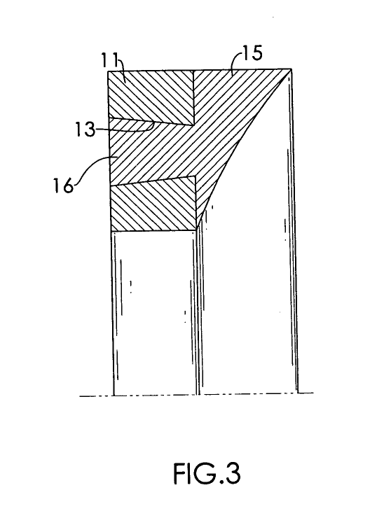

With further reference to FIG. 3, a main frame (20) in which the lens retainer (10) is mounted has a front, at least one opening (21), a lens recess (22), multiple mounting notches (23), a lens (26), a skirt (25), two sides and two buckles (24). The at least one opening (21) is formed through the main frame (20). The lens recess (22) is formed on the front of the main frame (20). The mounting notches (23) are formed inside of the lens recess (22). The buckles (24) are mounted respectively on the sides of the main frame (20) to attach a strap to the main frame (20).

The lens retainer (10) made with the method has a profile and main frame (20) interfaces, is mounted in the main frame (20) to hold the lens (26) and the skirt (25) in the main frame (20) and comprises a frame (11) and a crown (15).

Preparing the frame (11) comprises fabricating a frame (11) having at least one opening (12), a front edge, multiple interface holes (13), an outer edge and multiple optional mounting protrusions (14). The at least one opening (12) is formed through the frame (11). The interface holes (13) are formed through the front edge of the frame (11) and may be conical. The protrusions (14) are formed on and protrude out from the outer edge of the frame (11).

Then a mold is mounted on the front edge of the frame (11) over the interface holes (13).

With the mold securely mounted on the front edge of the frame (11), the mold is filled with liquid plastic to form a crown (15) on the front edge of the frame (11). The liquid plastic may be a different color from the frame (11). The liquid plastic also fills the interface holes (13) to form conical rods (16) respectively in the interface holes (13) to securely hold the crown (15) on the frame (11).

Curing the liquid plastic in the mold complete the process of forming the crown (15) on the front edge of the frame (11).

The mold is removed from the top of the frame (10) and the lens retainer (10) is ready to be mounted on an appropriate dive mask.

Even if the plastic of the crown (15) separates from the frame (11) after extensive use, the conical rods (16) of the crown (15) in the interface holes (13) in the frame (10) will prevent the crown (15) from separating from the frame (11), and the lens retainer (10) stay together and look good.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A method for making a lens retainer (10) comprising steps of
preparing a frame (11) having
at least one opening (12) formed through the frame (11);
a front edge; and
multiple interface holes (13) formed through the front edge of the frame (11);
mounting a mold on the front edge of the frame (11);
filling the mold and interface holes (13) with liquid plastic to form a crown (15) on the front edge of the frame (11) and having multiple rods (16) formed in the holes (13) of the frame (11);
curing the liquid plastic; and
removing the mold.

2. The method as claimed in claim 1, wherein the interface holes (13) in the frame (11) are conical.
